(19) United States
(12) Patent Application Publication
(10) Pub. No.: US 2026/0276956 A1
(43) Pub. Date: Sep. 17, 2026

(54) IMAGING LENS SYSTEM

(71) Applicant: SAMSUNG ELECTRO-MECHANICS CO., LTD., Suwon-si (KR)

(72) Inventor: Kil Soo SHIN, Suwon-si (KR)

(73) Assignee: SAMSUNG ELECTRO-MECHANICS CO., LTD., Suwon-si (KR)

(21) Appl. No.: 19/450,104

(22) Filed: Jan. 15, 2026

(30) Foreign Application Priority Data
Mar. 12, 2025 (KR) 10-2025-0032003

(51) Int. Cl. G02B 13/00; G02B 9/60; G02B 27/00; H04N 23/55

(52) U.S. Cl. CPC G02B 13/0055; G02B 9/60; G02B 13/0045; G02B 27/0056; H04N 23/55

(57) ABSTRACT

An imaging lens system includes a first lens, a second lens, a third lens, a fourth lens, and a fifth lens sequentially disposed from an object side. At least one of the first to fifth lenses is a metalens.

### CROSS-REFERENCE TO RELATED APPLICATIONS

This application claims the benefit under 35 USC 119 (a) of Korean Patent Application No. 10-2025-0032003 filed on Mar. 12, 2025, in the Korean Intellectual Property Office, the entire disclosure of which is incorporated herein by reference for all purposes.

### BACKGROUND

### 1. Field

The present disclosure relates to an imaging lens system capable of being thinned.

### 2. Description of the Background

A portable electronic device may include a camera module for capturing still images or recording moving images. For example, the camera module may be mounted in a mobile phone, a laptop computer, a game machine, or the like. The portable electronic device may be generally manufactured in a thin or compact form to improve portability for a user. However, the camera module including a plurality of lenses is difficult to be thinned due to convex or concave shapes of the lenses. In addition, the camera module including the lenses having convex and concave shapes inevitably causes chromatic aberration due to the lens shapes, making aberration correction difficult.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens, a second lens, a third lens, a fourth lens, and a fifth lens sequentially disposed from an object side. At least one of the first lens to the fifth lens is a metalens.

The metalens may have positive refractive power.

The first lens or the second lens may be the metalens.

The fourth lens may be the metalens.

At least one of the first lens to the fifth lens may have negative refractive power.

One pair of adjacent lenses among the first lens to the fifth lens may each have positive refractive power.

One of the second lens to the fourth lens may have negative refractive power.

The metalens may include a first region corresponding to a blue wavelength, a second region corresponding to a green wavelength, a third region corresponding to a red wavelength, and a fourth region corresponding to a green wavelength.

The first region and the second region may be respectively symmetrical to the third region and the fourth region about an optical axis.

In another general aspect, an imaging lens system includes a lens group disposed between an object and an image plane, wherein the lens group includes at least one metalens. The lens group may include a lens having negative refractive power.

The imaging lens system may satisfy the following conditional expression: 0.60<TTL/2Y<0.80, where TTL is a distance from an object-side surface of a foremost lens disposed foremost in the lens group to the image plane and 2Y is a diagonal length of the image plane.

The imaging lens system may satisfy the following conditional expression: 0.4<BFL/f<1.0, where BFL is a distance from an image-side surface of a rearmost lens disposed rearmost in the lens group to the image plane and f is a focal length of the imaging lens system.

Other features and aspects will be apparent from the following detailed description, the drawings, and the claims.

### BRIEF DESCRIPTION OF DRAWINGS

FIG. 1 is a configuration diagram of an imaging lens system (based on a red wavelength) according to a first example embodiment.

FIG. 2 is an aberration curve of the imaging lens system illustrated in FIG. 1.

FIG. 3 is a configuration diagram of an imaging lens system (based on a green wavelength) according to a first example embodiment.

FIG. 4 is an aberration curve of the imaging lens system illustrated in FIG. 3.

FIG. 5 is a configuration diagram of an imaging lens system (based on a blue wavelength) according to a first example embodiment.

FIG. 6 is an aberration curve of the imaging lens system illustrated in FIG. 5.

FIGS. 7 to 9 are configuration diagrams of a metalens according to an example embodiment and a modification.

FIG. 10 is a configuration diagram of an image sensor illustrated in FIG. 1, 3, or 5.

FIG. 11 is a configuration diagram of an imaging lens system (based on a red wavelength) according to a second example embodiment.

FIG. 12 is an aberration curve of the imaging lens system illustrated in FIG. 11.

FIG. 13 is a configuration diagram of an imaging lens system (based on a green wavelength) according to a second example embodiment.

FIG. 14 is an aberration curve of the imaging lens system illustrated in FIG. 13.

FIG. 15 is a configuration diagram of an imaging lens system (based on a blue wavelength) according to a second example embodiment.

FIG. 16 is an aberration curve of the imaging lens system illustrated in FIG. 15.

FIG. 17 is a configuration diagram of an imaging lens system (based on a red wavelength) according to a third example embodiment.

FIG. 18 is an aberration curve of the imaging lens system illustrated in FIG. 17.

FIG. 19 is a configuration diagram of an imaging lens system (based on a green wavelength) according to a third example embodiment.

FIG. 20 is an aberration curve of the imaging lens system illustrated in FIG. 19.

FIG. 21 is a configuration diagram of an imaging lens system (based on a blue wavelength) according to a third example embodiment.

FIG. 22 is an aberration curve of the imaging lens system illustrated in FIG. 21.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

In describing the present disclosure below, terms indicating components of the present disclosure will be named in consideration of functions of each component. Therefore, the terms should not be understood as being limited technical components of the present disclosure.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an imaging lens system capable of thinning of a camera module.

An aspect of the present disclosure is to provide an imaging lens system capable of correcting chromatic aberration of a camera module.

An aspect of the present disclosure is to provide an imaging lens system capable of improving polychromatic light transmittance of a camera module.

In the present specification, a foremost lens or a first lens indicates a lens closest to an object (or a subject), and a rearmost lens or a fifth lens indicates a lens closest to an image plane (or an image sensor). In the present specification, the radius of curvature, thickness, a total track length (TTL: a distance from an object-side surface of the first lens to the image plane), ImgHT (or Y: a height of the image plane), and focal length of the lenses may be represented by millimeters (mm).

The thickness of the lens, spacing between lenses, and the TTL are distances along an optical axis of the lenses. In addition, in a description of a shape of the lens, one convex surface of the lens may indicate that a paraxial region of a corresponding surface is convex, and one concave surface of the lens may indicate that the paraxial region of a corresponding surface is concave. Therefore, although it is described that one surface of the lens is convex, an edge portion of the lens may be concave. Similarly, although it is described that one surface of the lens is concave, an edge portion of the lens may be convex.

An imaging lens system according to the present specification may be mounted in all kinds and types of camera devices. For example, the imaging lens system may be mounted in a mobile terminal, a laptop computer, or a camera device for a virtual reality (VR) apparatus. However, the types of camera devices in which the imaging lens system according to the present disclosure may be mounted are not limited to the above devices. For example, the imaging lens system may also be mounted in a camera device for front and rear monitoring that is installed in a vehicle or a camera device for autonomous driving.

An imaging lens system according to a first aspect of the present disclosure may include a plurality of lenses. For example, the imaging lens system according to this aspect may include a first lens, a second lens, a third lens, a fourth lens, and a fifth lens sequentially disposed from an object side. However, a configuration of the imaging lens system according to this aspect is not limited to the first to fifth lenses. The imaging lens system according to this aspect may include at least one metalens. For example, at least one of the first to fifth lenses may be a metalens.

An imaging lens system according to a second aspect of the present disclosure may include a lens group including at least one metalens. For example, the lens group according to this aspect may include five lenses, and at least one of the five lenses may be a metalens. In the imaging lens system according to this aspect, the lens group may be disposed between an object and an image plane. More specifically, the lens group according to this aspect may be disposed at a predetermined distance from the image plane.

An imaging lens system according to a third aspect of the present disclosure may include at least one metalens. For example, the imaging lens system according to this aspect may include at least two metalenses. The imaging lens system according to this aspect may include a metalens having a unique form. For example, the metalens according to this aspect may include a first region corresponding to a blue wavelength, a second region corresponding to a green wavelength, a third region corresponding to a red wavelength, and a fourth region corresponding to a green wavelength sequentially disposed in a clockwise direction or a counterclockwise direction.

An imaging lens system according to a fourth aspect of the present disclosure may include at least one metalens. For example, the imaging lens system according to this aspect may include at least two metalenses. The imaging lens system according to this aspect may include a metalens having a unique form. For example, the metalens according to this aspect may include a first region corresponding to a blue wavelength, a second region corresponding to a green wavelength, and a third region corresponding to a red wavelength. In addition, the metalens according to this aspect may further include a unique region. For example, in the metalens according to this aspect, the second region corresponding to a green wavelength may be larger than the first region corresponding to a blue wavelength. In another example, in the metalens according to this aspect, the second region corresponding to a green wavelength may be larger than the third region corresponding to a red wavelength. In yet another example, in the metalens according to this aspect, the second region corresponding to a green wavelength may be equal to or larger than a sum of the first region and the third region.

An imaging lens system according to a fifth aspect of the present disclosure may satisfy at least one of the following conditional expressions:

$$- 4.0 < f 1 / f < 12.$$

$$- 6. < f 2 / f < 1.2$$

$$- 6. < f 3 / f < 50$$

$$- 1. < f 4 / f < 2.$$

$$- 1. < f 5 / f < 7.$$

$$0.9 < TTL / f < 1.3$$

$$- 8. < f 1 / f 2 < 15$$

$$- 1. < f 2 / f 3 < 1.$$

$$0.4 < BFL / f < 1.$$

$$0.6 < TTL / 2 Y < 0.80 .$$

In the above conditional expressions, f indicates a focal length of the imaging lens system, f1 indicates a focal length of the first lens, f2 indicates a focal length of the second lens, f3 indicates a focal length of the third lens, f4 indicates a focal length of the fourth lens, f5 indicates a focal length of the fifth lens, TTL indicates a distance from an object-side surface of the first lens (or a foremost lens disposed foremost in the lens group) to the image plane, a back focal length (BFL) indicates a distance from an image-side surface of the fifth lens (or a rearmost lens disposed rearmost in the lens group) to the image plane, and 2Y indicates a diagonal length of the image plane (2 lmgHT).

The above-described conditional expressions may indicate numerical ranges for optimizing refractive powers of the first to fifth lenses and a size of the imaging lens system in an optical axis direction.

An imaging lens system according to a sixth aspect of the present disclosure may satisfy at least one of the following conditional expressions:

$$0.4 < fM / f < 12$$

$$0.4 < fMg / f < 6.$$

$$- 0.8 \; 0 < MS 1 < - 0.10$$

$$0.08 < MS 2 < 0.6$$

$$0.6 < \vert f 12 / f 2 \vert < 3.$$

$$0.4 < f 34 / f < 1.6 .$$

In the above conditional expressions, fM indicates a focal length of a foremost metalens disposed closest to an object in the lens group (or the first to fifth lenses) included in the imaging lens system, fMg indicates a focal length of the foremost metalens in a green wavelength, MS1 indicates a second-order coefficient of a phase function of an object-side surface of the foremost metalens, MS2 indicates a second-order coefficient of a phase function of an image-side surface of the foremost metalens, f12 indicates a combined focal length of the first lens and the second lens, and f34 indicates a combined focal length of the third lens and the fourth lens.

The above-described conditional expressions may indicate numerical ranges for optimizing refractive power of the foremost metalens and refractive powers of the first to fourth lenses.

An imaging lens system according to a seventh aspect of the present disclosure may include at least two of the features of the imaging lens systems according to the above aspects. For example, the imaging lens system according to this aspect may include the feature of the first aspect and satisfy at least one of the conditional expressions according to the fifth or sixth aspect. In another example, the imaging lens system according to this aspect may include at least one of the features of the second to fourth aspects and satisfy at least one of the conditional expressions according to the fifth or sixth aspect.

The imaging lens system according to the present specification may further include at least one lens having the following features as necessary. For example, the imaging lens system according to the first aspect may include one of the first to fifth lenses having the following features. In another example, the imaging lens system according to the second to seventh aspects may include at least one of the first to fifth lenses having the following features. However, the imaging lens system according to the above aspects is not necessarily required to include the lenses having the following features. Hereinafter, the features of the first to fifth lenses are described.

The first lens has refractive power. For example, the first lens may have positive or negative refractive power. The first lens may have a predetermined refractive index. For example, the refractive index of the first lens may be greater than 1.4. In a specific example, the refractive index of the first lens may be greater than 1.4 and less than 1.6. The first lens may have a predetermined Abbe number. For example, the Abbe number of the first lens may be 50 or more.

The second lens has refractive power. For example, the second lens may have positive or negative refractive power. The second lens may have a predetermined refractive index and a predetermined Abbe number. For example, the refractive index of the second lens may be greater than 1.4, and the Abbe number of the second lens may be greater than 20. In a specific example, when the second lens has positive refractive power, the refractive index of the second lens may be 1.4 or more, and the Abbe number of the second lens may be 60 or more. In another example, when the second lens has negative refractive power, the refractive index of the second lens may be 1.6 or more, and the Abbe number of the second lens may be less than 30.

The third lens has refractive power. For example, the third lens may have positive or negative refractive power. The third lens may have a predetermined refractive index. For example, the refractive index of the third lens may be greater than 1.4. In a specific example, the refractive index of the third lens may be greater than 1.4 and less than 1.6. The third lens may have a predetermined Abbe number. For example, the Abbe number of the third lens may be 50 or more.

The fourth lens has refractive power. For example, the fourth lens may have positive or negative refractive power. The fourth lens may have a predetermined refractive index. For example, the refractive index of the fourth lens may be greater than 1.4. In a specific example, the refractive index of the fourth lens may be greater than 1.4 and less than 1.6. The fourth lens may have a predetermined Abbe number. For example, the Abbe number of the fourth lens may be 50 or more.

The fifth lens has refractive power. For example, the fifth lens may have positive or negative refractive power. The fifth lens may have a predetermined refractive index. For example, the refractive index of the fifth lens may be greater than 1.4. In a specific example, the refractive index of the fifth lens may be greater than 1.4 and less than 1.6. The fifth lens may have a predetermined Abbe number. For example, the Abbe number of the fifth lens may be 50 or more.

At least one of the first to fifth lenses may be a metalens. For example, the first lens or the second lens may be a metalens. In another example, the fourth lens may be a metalens. A metalens among the first to fifth lenses may include a unique feature. For example, a metalens among the first to fifth lenses may have positive refractive power.

A metalens may include nanostructures. For example, the metalens may include the nanostructures, a band pass filter, and a substrate. The nanostructures may transmit light in a specific wavelength band. The nanostructures may be arranged in a first direction and a second direction intersecting an optical axis. The nanostructures may have forms such as polygonal prisms or circular columns having predetermined heights and cross-sectional areas. However, the form of the nanostructures is not limited to polygonal prisms or circular columns.

At least one lens of the lens group included in the imaging lens system, the first to fifth lenses, or the second to fourth lenses may have negative refractive power. For example, the first lens may have negative refractive power. In another example, the second lens may have negative refractive power. One pair of adjacent lenses among the first to fifth lenses may have positive refractive power. For example, the first lens and the second lens may both have positive refractive power. In another example, the second lens and the third lens may both have positive refractive power. In yet another example, the third lens and the fourth lens may both have positive refractive power.

Each of the first to fifth lenses may have a spherical shape or an aspherical shape as necessary. The aspherical shape of each of the first to fifth lenses may be expressed by Equation 1.

$$Z = \frac{c {r}^{2}}{1 + \sqrt{1 - ( 1 + k ) {c}^{2} {r}^{2}}} + A {r}^{4} + B {r}^{6} + C {r}^{8} + D {r}^{10} + {Er}^{12} + F {r}^{14} + G {r}^{16} + H {r}^{18} + J {r}^{20} … \qquad [ Equation 1 ]$$

In Equation 1, c is a curvature of a lens surface and is equal to a reciprocal of a radius of curvature of the lens surface at an optical axis of the lens surface, k is a conic constant, r is a distance from any point on the lens surface to the optical axis of the lens surface in a direction perpendicular to the optical axis of the lens surface, A to H and J are aspheric constants, and Z (also known as SAG) is a distance in a direction parallel to the optical axis of the lens surface from the point on the lens surface at the distance r from the optical axis of the lens surface to a tangential plane perpendicular to the optical axis and intersecting a vertex of the lens surface.

The imaging lens system according to the above-described example embodiments or aspects may further include a filter. The filter may be disposed between the rearmost lens (the fifth lens) and the image plane. The filter may block light of a specific wavelength. For reference, the filter described in the present specification may block infrared light, and the wavelength of light blocked by the filter is not limited to infrared light.

Hereinafter, a specific example embodiment of the imaging lens system according to the present disclosure is described with reference to the drawings.

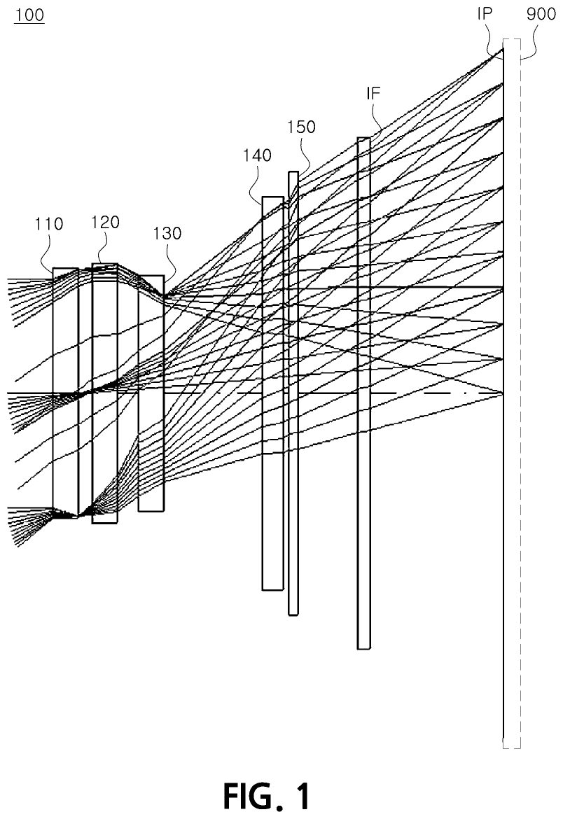

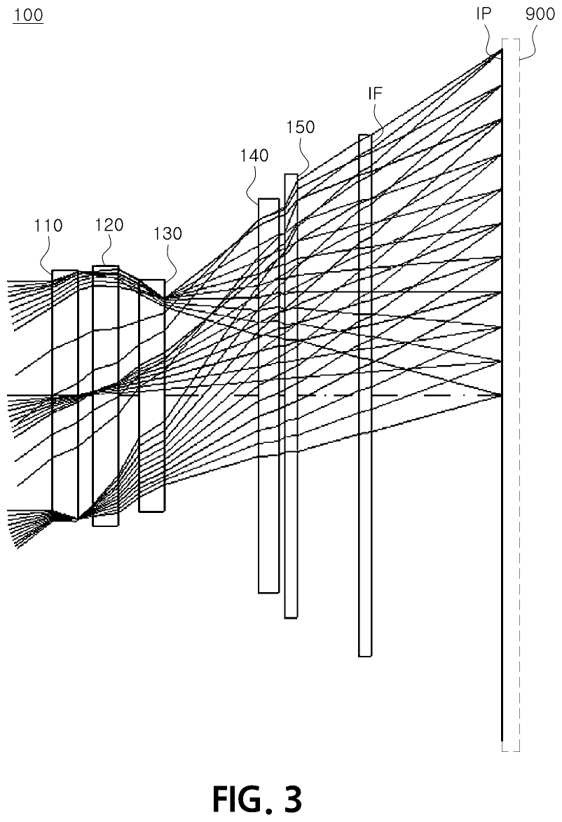

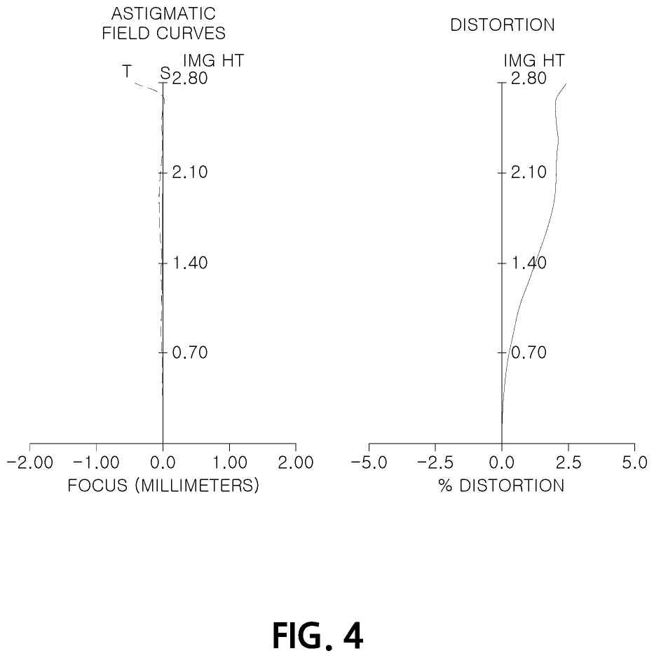

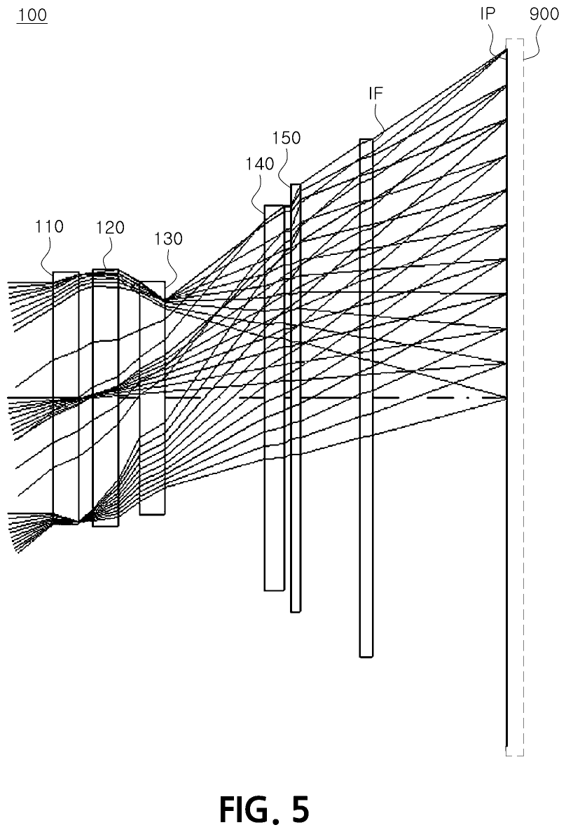

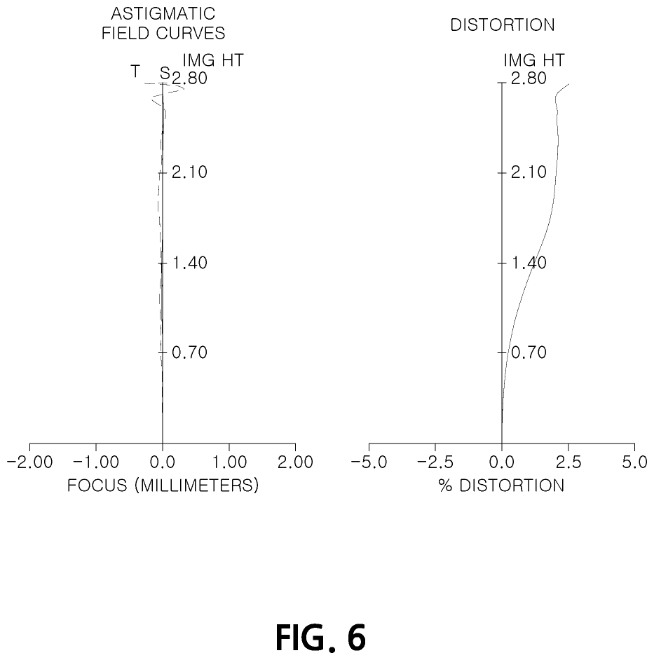

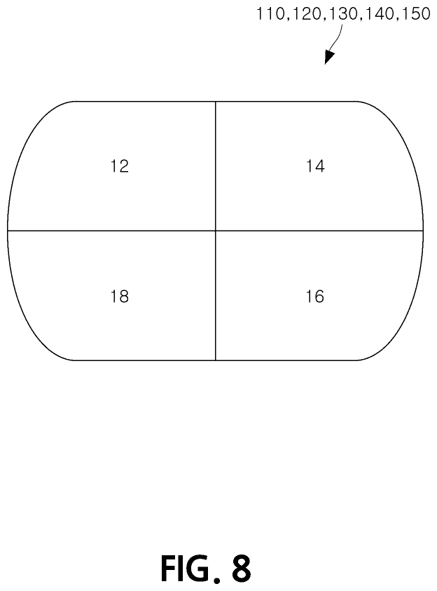

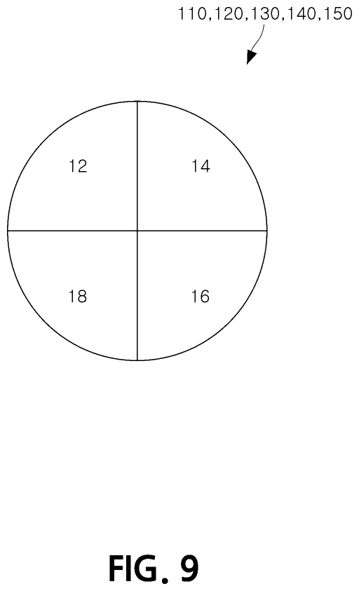

First, an imaging lens system according to a first example embodiment is described with reference to FIGS. 1 to 10.

An imaging lens system 100 may include a lens group. For example, the imaging lens system 100 may include one lens group disposed between an object and an image plane IP. The lens group may include at least one lens. For example, the lens group of the imaging lens system 100 may include a first lens 110, a second lens 120, a third lens 130, a fourth lens 140, and a fifth lens 150.

Each of the first lens 110 to the fifth lens 150 may have predetermined refractive power. For example, the first lens 110 may have positive refractive power, the second lens 120 may have positive refractive power, the third lens 130 may have negative refractive power, the fourth lens 140 may have positive refractive power, and the fifth lens 150 may have negative refractive power.

The imaging lens system 100 may include at least one metalens. For example, in the imaging lens system 100 according to this example embodiment, the first lens 110 to the fifth lens 150 may all be metalenses. The first lens 110 to the fifth lens 150 that are metalenses may have substantially planar object-side and image-side surfaces.

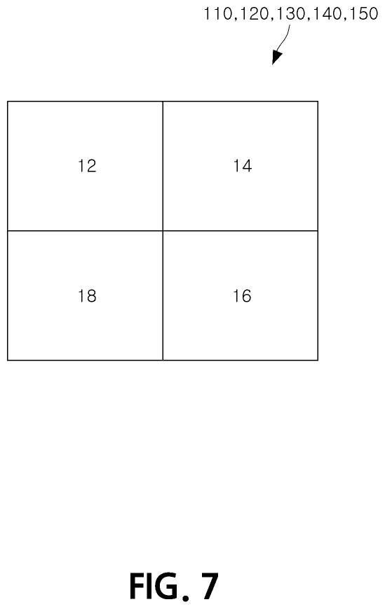

Each of the metalenses 110, 120, 130, 140, and 150 may have a unique form. For example, as illustrated in FIGS. 7 to 9, each of the metalenses 110, 120, 130, 140, and 150 may be formed in a quadrangular shape, a rectangular shape, or a circular shape. However, the metalenses 110, 120, 130, 140, and 150 are not limited to the forms illustrated in FIGS. 7 to 9.

Each of the metalenses 110, 120, 130, 140, and 150 may be partitioned into a plurality of regions. For example, each of the metalenses 110, 120, 130, 140, and 150 may include a first region 12 of a blue wavelength, a second region 14 of a green wavelength, a third region 16 of a red wavelength, and a fourth region 18 of a green wavelength. The first region 12 of a blue wavelength, the second region 14 of a green wavelength, the third region 16 of a red wavelength, and the fourth region 18 of a green wavelength may be disposed in a predetermined form. For example, the first region 12 of a blue wavelength, the second region 14 of a green wavelength, the third region 16 of a red wavelength, and the fourth region 18 of a green wavelength may be sequentially formed about an optical axis in the clockwise direction or the counterclockwise direction. In another example, the first region 12 of a blue wavelength may be disposed to be symmetrical to the region 16 of a red wavelength about the optical axis, and the second region 14 of a green wavelength may be disposed to be symmetrical to the fourth region 18 of a green wavelength about the optical axis.

The imaging lens system 100 may include a filter IF and the image plane IP. The filter IF may be disposed between the fifth lens 150 and the image plane IP. The image plane IP may be formed on an image sensor 900.

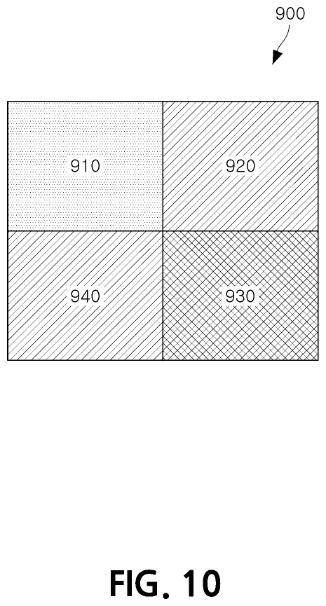

The image sensor 900 according to this example embodiment may have features similar to those of the metalenses 110, 120, 130, 140, and 150. For example, as illustrated in FIG. 10, the image sensor 900 may be partitioned into a plurality of regions. In a specific example, the image sensor 900 may include a first region 910 of a blue wavelength, a second region 920 of a green wavelength, a third region 930 of a red wavelength, and a fourth region 940 of a green wavelength. The first region 910 of a blue wavelength, the second region 920 of a green wavelength, the third region 930 of a red wavelength, and the fourth region 940 of a green wavelength may be disposed in a predetermined form. For example, the first region 910 of a blue wavelength, the second region 920 of a green wavelength, the third region 930 of a red wavelength, and the fourth region 940 of a green wavelength may be sequentially formed about the optical axis in the clockwise direction or the counterclockwise direction. In another example, the first region 910 of a blue wavelength may be disposed to be symmetrical to the region 930 of a red wavelength about the optical axis, and the second region 920 of a green wavelength may be disposed to be symmetrical to the fourth region 940 of a green wavelength about the optical axis.

The first region 910 of a blue wavelength, the second region 920 of a green wavelength, the third region 930 of a red wavelength, and the fourth region 940 of a green wavelength of the image sensor 900 may independently converge light emitted from the first to fourth regions 12 to 18 of the metalenses 110, 120, 130, 140, and 150. For example, the first region 910 of the image sensor 900 corresponding to a blue wavelength may image light refracted by the first regions 12 of the metalenses 110, 120, 130, 140, and 150, the second region 920 and the fourth region 940 of the image sensor 900 corresponding to a green wavelength may image light refracted by the second regions 14 and the fourth regions 18 of the metalenses 110, 120, 130, 140, and 150, and the third region 930 of the image sensor 900 corresponding to a red wavelength may image light refracted by the third regions 16 of the metalenses 110, 120, 130, 140, and 150.

The imaging lens system 100 configured as described above may independently converge light of a blue wavelength, a green wavelength, and a red wavelength through at least one of the metalenses 110, 120, 130, 140, and 150 to implement a clear image. In addition, the imaging lens system 100 according to this example embodiment includes the thin metalenses 110, 120, 130, 140, and 150, thereby significantly reducing a size of the imaging lens system 100.

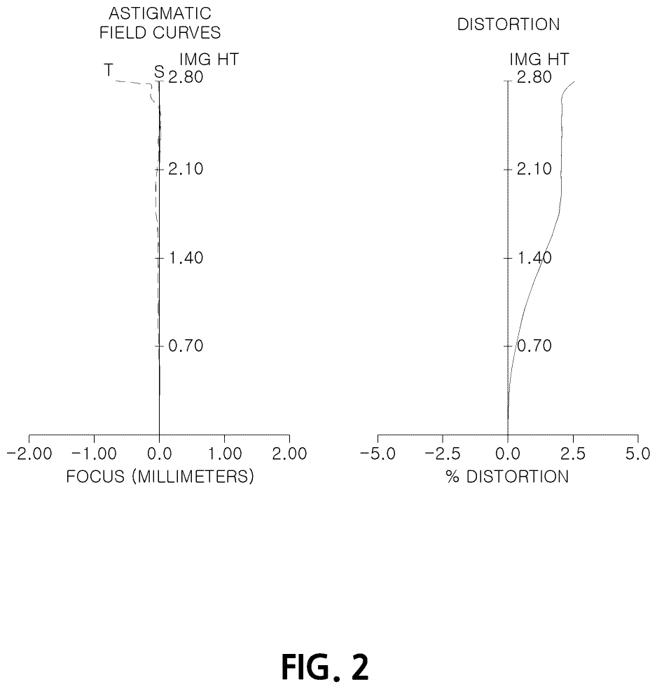

FIGS. 2, 4, and 6 illustrate aberration feature of the imaging lens system 100 according to this example embodiment. Tables 1 to 3 show lens features of the imaging lens system 100 according to this example embodiment, and Tables 4 to 6 show phase function values of the imaging lens system 100 according to this example embodiment.

TABLE 1

| Surface | | Radius of | Thickness/ | Refractive | Abbe | Focal |
|---|---|---|---|---|---|---|
| No. | Configuration | Curvature | Distance | Index | Number | Length |
| S1 | First lens | infinity | 0.2100 | 1.4564 | 67.7954 | 33.027 |
| S2 | | infinity | 0.1099 | 1 | 0 | |
| S3 | Second | infinity | 0.2100 | 1.4564 | 67.7954 | 2.783 |
| | lens | | | | | |
| S4 | | infinity | 0.1730 | 1 | 0 | |
| S5 | Third lens | infinity | 0.2100 | 1.4564 | 67.7954 | −9.652 |
| S6 | | infinity | 0.8093 | 1 | 0 | |
| S7 | Fourth | infinity | 0.1700 | 1.4564 | 67.7954 | 1.819 |
| | lens | | | | | |
| S8 | | infinity | 0.0496 | 1 | 0 | |
| S9 | Fifth lens | infinity | 0.0782 | 1.4564 | 67.7954 | −1.988 |
| S10 | | infinity | 0.4830 | 1 | 0 | |
| S11 | Filter | infinity | 0.1100 | 1.5143 | 64.1664 | |
| S12 | | infinity | 1.0871 | 1 | 0 | |
| S13 | Image | infinity | 0.0000 | 1 | 0 | |
| | plane | | | | | |

TABLE 2

| Surface | | Radius of | Thickness/ | Refractive | Abbe | Focal |
|---|---|---|---|---|---|---|
| No. | Configuration | Curvature | Distance | Index | Number | Length |
| S1 | First lens | infinity | 0.2100 | 1.4601 | 67.7954 | 19.161 |
| S2 | | infinity | 0.1242 | 1 | 0 | |
| S3 | Second lens | infinity | 0.2100 | 1.4601 | 67.7954 | 3.171 |
| S4 | | infinity | 0.1726 | 1 | 0 | |
| S5 | Third lens | infinity | 0.2100 | 1.4601 | 67.7954 | −15.702 |
| S6 | | infinity | 0.7688 | 1 | 0 | |
| S7 | Fourth lens | infinity | 0.1700 | 1.4601 | 67.7954 | 1.430 |
| S8 | | infinity | 0.0500 | 1 | 0 | |
| S9 | Fifth lens | infinity | 0.1043 | 1.4601 | 67.7954 | −1.526 |
| S10 | | infinity | 0.5010 | 1 | 0 | |
| S11 | Filter | infinity | 0.1100 | 1.5187 | 64.1664 | |
| S12 | | infinity | 1.0690 | 1 | 0 | |
| S13 | Image plane | infinity | 0.0000 | 1 | 0 | |

TABLE 3

| Surface | | Radius of | Thickness/ | Refractive | Abbe | Focal |
|---|---|---|---|---|---|---|
| No. | Configuration | Curvature | Distance | Index | Number | Length |
| S1 | First lens | infinity | 0.2100 | 1.4667 | 67.7954 | 38.616 |
| S2 | | infinity | 0.1094 | 1 | 0 | |
| S3 | Second lens | infinity | 0.2100 | 1.4667 | 67.7954 | 2.702 |
| S4 | | infinity | 0.1697 | 1 | 0 | |
| S5 | Third lens | infinity | 0.2100 | 1.4667 | 67.7954 | −9.117 |
| S6 | | infinity | 0.8087 | 1 | 0 | |
| S7 | Fourth lens | infinity | 0.1700 | 1.4667 | 67.7954 | 1.680 |
| S8 | | infinity | 0.0519 | 1 | 0 | |
| S9 | Fifth lens | infinity | 0.0803 | 1.4667 | 67.7954 | −1.832 |
| S10 | | infinity | 0.4815 | 1 | 0 | |
| S11 | Filter | infinity | 0.1100 | 1.5267 | 64.1664 | |
| S12 | | infinity | 1.0885 | 1 | 0 | |
| S13 | Image plane | infinity | 0.0000 | 1 | 0 | |

TABLE 4

| Surface | | | | | | | | |
|---|---|---|---|---|---|---|---|---|
| No. | K/2nd | K/2nd | 4th | 6th | 8th | 10th | 12th | 14th |
| S1 | −0.1121 | −0.1121 | 0.3091 | −0.0163 | 0.0298 | −0.0993 | −0.0275 | 0.0344 |
| S2 | 0.1002 | 0.1002 | −0.521 | 0.3152 | −0.0853 | 0.0012 | 0.0422 | 0.0059 |
| S3 | −0.4902 | −0.4902 | 0.2633 | −0.1732 | 0.0167 | 0.0547 | 0.0036 | −0.0152 |
| S4 | 0.3617 | 0.3617 | −0.2032 | −0.0169 | −0.0276 | −0.0459 | 0.0092 | 0.0038 |
| S5 | 0.176 | 0.176 | −0.095 | 0.0222 | −0.1048 | −0.0181 | −0.0149 | −0.0143 |
| S6 | −0.1182 | −0.1182 | 0.1934 | 0.0705 | 0.1861 | 0.0013 | 0.2782 | 0.1858 |
| S7 | 0.2255 | 0.2255 | 0.0396 | −0.0728 | 0.019 | 0.0068 | −0.0029 | −0.001 |
| S8 | −0.4754 | −0.4754 | 0.0882 | 0.0602 | −0.0226 | −0.0059 | −0.0027 | 0.0013 |
| S9 | 0.4593 | 0.4593 | −0.203 | 0.0248 | 0.0274 | −0.0029 | −0.0025 | 0.0008 |
| S10 | −0.198 | −0.198 | 0.0699 | −0.0321 | −0.0086 | 0.0022 | 0.002 | 0.0004 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | 0.024 | −0.0019 | −0.0082 | 0 | 0 | 0 | 0 | 0 |
| S2 | −0.0301 | −0.0274 | 0.0241 | 0 | 0 | 0 | 0 | 0 |
| S3 | 0.0058 | 0.0221 | −0.0007 | 0 | 0 | 0 | 0 | 0 |
| S4 | 0.0062 | 0.0105 | −0.0063 | 0 | 0 | 0 | 0 | 0 |
| S5 | 0.033 | 0.0605 | −0.0453 | 0 | 0 | 0 | 0 | 0 |
| S6 | −0.4433 | −0.5202 | 1.963 | 0 | 0 | 0 | 0 | 0 |
| S7 | 0.0002 | 0.0002 | 0 | 0 | 0 | 0 | 0 | 0 |
| S8 | 0.0008 | −0.0002 | 0 | 0 | 0 | 0 | 0 | 0 |
| S9 | 0.0005 | −0.0005 | 0.0001 | 0 | 0 | 0 | 0 | 0 |
| S10 | −0.0007 | 0.0002 | 0 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

TABLE 5

| Surface | | | | | | | | |
|---|---|---|---|---|---|---|---|---|
| No. | K | 2nd | 4th | 6th | 8th | 10th | 12th | 14th |
| S1 | −0.1236 | −0.1236 | 0.3061 | −0.0116 | 0.0245 | −0.0763 | −0.0293 | 0.0216 |
| S2 | 0.1011 | 0.1011 | −0.5113 | 0.2868 | −0.0759 | 0.002 | 0.0319 | 0.0027 |
| S3 | −0.4691 | −0.4691 | 0.255 | −0.149 | −0.0001 | 0.0589 | 0.0097 | −0.0161 |
| S4 | 0.36 | 0.36 | −0.2151 | 0.0067 | −0.0288 | −0.0562 | 0.0091 | 0.0112 |
| S5 | 0.1523 | 0.1523 | −0.058 | −0.0221 | −0.087 | −0.0164 | −0.0053 | −0.0026 |
| S6 | −0.1154 | −0.1154 | 0.171 | 0.0747 | 0.167 | 0.1363 | 0.1109 | −0.0179 |
| S7 | 0.2372 | 0.2372 | 0.0422 | −0.0737 | 0.0111 | 0.0091 | −0.0031 | −0.0006 |
| S8 | −0.5561 | −0.5561 | 0.116 | 0.0541 | −0.0215 | −0.0053 | −0.0026 | 0.0013 |
| S9 | 0.5939 | 0.5939 | −0.2436 | 0.0294 | 0.0273 | −0.0026 | −0.0024 | 0.0009 |
| S10 | −0.2454 | −0.2454 | 0.0675 | −0.0214 | −0.0098 | 0.0018 | 0.0017 | 0.0005 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | 0.0209 | 0.0059 | −0.0097 | 0 | 0 | 0 | 0 | 0 |
| S2 | −0.0209 | −0.0172 | 0.015 | 0 | 0 | 0 | 0 | 0 |
| S3 | 0.0009 | 0.0184 | 0.0017 | 0 | 0 | 0 | 0 | 0 |
| S4 | 0.0075 | 0.0039 | −0.0041 | 0 | 0 | 0 | 0 | 0 |
| S5 | 0.0202 | 0.0318 | −0.0224 | 0 | 0 | 0 | 0 | 0 |
| S6 | −0.2188 | −0.0179 | 1.2811 | 0 | 0 | 0 | 0 | 0 |
| S7 | 0 | 0.0001 | 0 | 0 | 0 | 0 | 0 | 0 |
| S8 | 0.0008 | −0.0002 | 0 | 0 | 0 | 0 | 0 | 0 |
| S9 | 0.0004 | −0.0005 | 0.0001 | 0 | 0 | 0 | 0 | 0 |
| S10 | −0.0007 | 0.0002 | 0 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

TABLE 6

| Surface | | | | | | | | |
|---|---|---|---|---|---|---|---|---|
| No. | K | 2nd | 4th | 6th | 8th | 10th | 12th | 14th |
| S1 | −0.1191 | −0.1191 | 0.3049 | −0.011 | 0.0204 | −0.0823 | −0.0289 | 0.0248 |
| S2 | 0.1099 | 0.1099 | −0.5141 | 0.2959 | −0.0771 | 0.0019 | 0.0339 | 0.0034 |
| S3 | −0.512 | −0.512 | 0.2698 | −0.1562 | 0.0079 | 0.0566 | 0.0062 | −0.0157 |
| S4 | 0.3831 | 0.3831 | −0.2358 | −0.0053 | −0.0235 | −0.0492 | 0.011 | 0.0085 |
| S5 | 0.2064 | 0.2064 | −0.096 | 0.0077 | −0.1038 | −0.0258 | −0.0096 | 0.0009 |
| S6 | −0.1431 | −0.1431 | 0.2049 | 0.0431 | 0.2488 | 0.0637 | 0.0041 | 0.0502 |
| S7 | 0.2074 | 0.2074 | 0.036 | −0.0643 | 0.0126 | 0.0087 | −0.003 | −0.0007 |
| S8 | −0.4818 | −0.4818 | 0.0922 | 0.0576 | −0.0228 | −0.0058 | −0.0026 | 0.0013 |
| S9 | 0.5302 | 0.5302 | −0.2153 | 0.0258 | 0.0269 | −0.0029 | −0.0024 | 0.0009 |
| S10 | −0.2431 | −0.2431 | 0.0724 | −0.028 | −0.0086 | 0.0022 | 0.0016 | 0.0005 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | 0.0221 | 0.0047 | −0.0105 | 0 | 0 | 0 | 0 | 0 |
| S2 | −0.023 | −0.0196 | 0.0178 | 0 | 0 | 0 | 0 | 0 |
| S3 | 0.0036 | 0.0201 | −0.0007 | 0 | 0 | 0 | 0 | 0 |
| S4 | 0.0048 | 0.0042 | −0.0033 | 0 | 0 | 0 | 0 | 0 |
| S5 | 0.0357 | 0.0494 | −0.0447 | 0 | 0 | 0 | 0 | 0 |
| S6 | 0.072 | 0.2223 | 0.5888 | 0 | 0 | 0 | 0 | 0 |
| S7 | 0 | 0.0001 | 0 | 0 | 0 | 0 | 0 | 0 |
| S8 | 0.0009 | −0.0002 | 0 | 0 | 0 | 0 | 0 | 0 |
| S9 | 0.0004 | −0.0005 | 0.0001 | 0 | 0 | 0 | 0 | 0 |
| S10 | −0.0008 | 0.0002 | 0 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

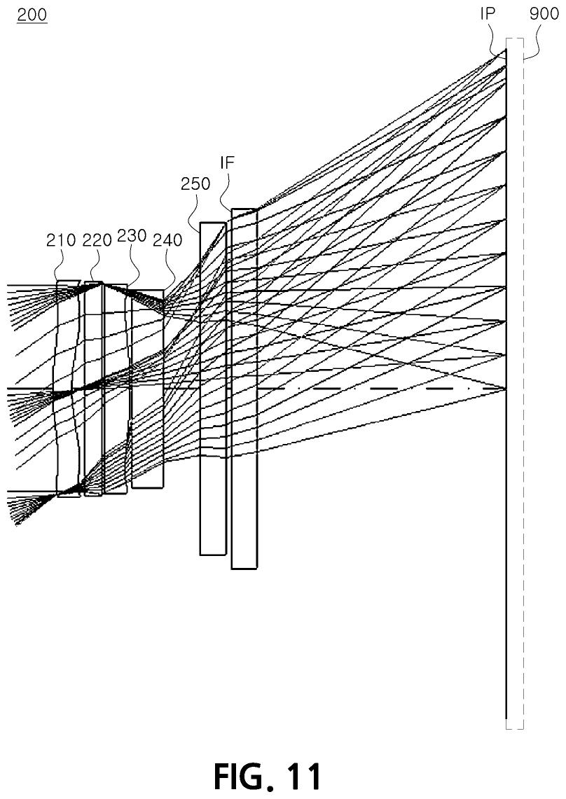

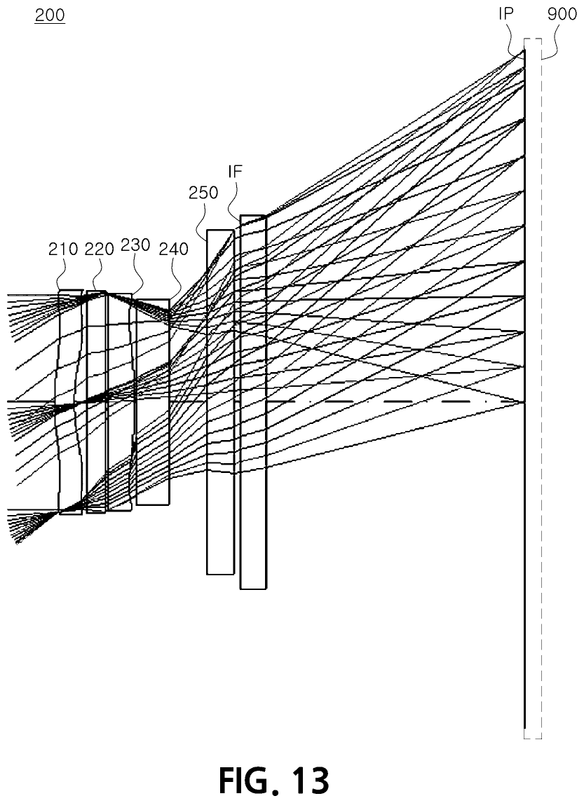

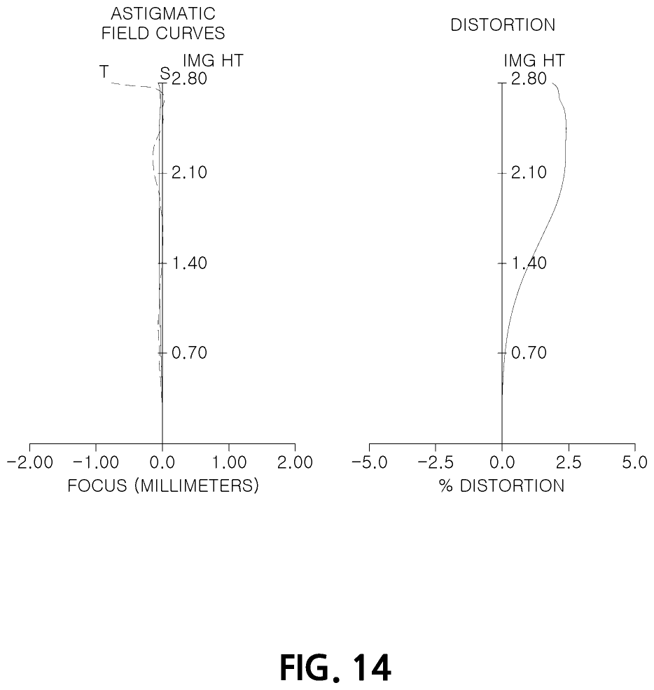

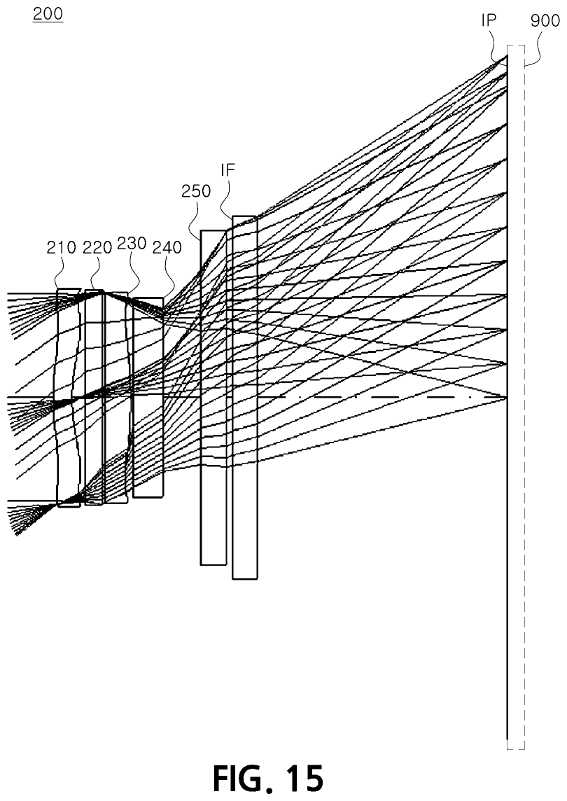

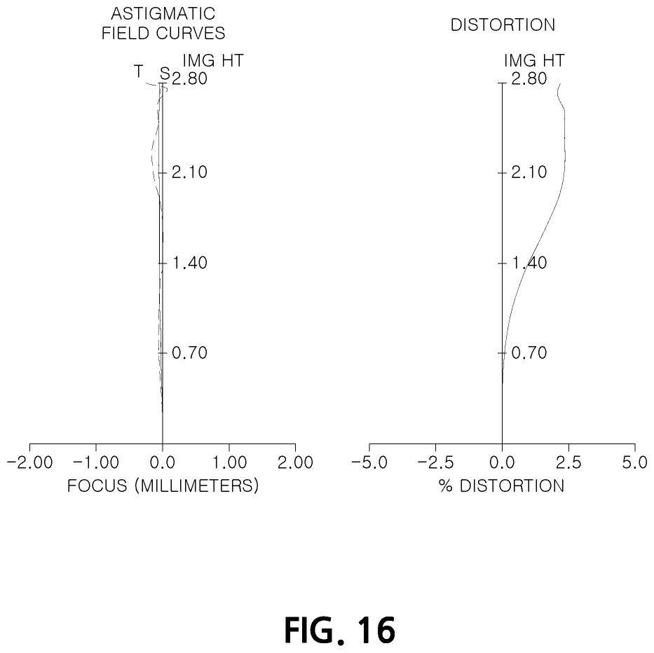

Hereinafter, an imaging lens system according to a second example embodiment is described with reference to FIGS. 11 to 16.

An imaging lens system 200 may include a lens group. For example, the imaging lens system 200 may include one lens group disposed between an object and an imaging plane IP. The lens group may include at least one lens. For example, the lens group of the imaging lens system 200 may include a first lens 210, a second lens 220, a third lens 230, a fourth lens 240, and a fifth lens 250.

Each of the first lens 210 to the fifth lens 250 may have predetermined refractive power. For example, the first lens 210 has negative refractive power, the second lens 220 has positive refractive power, the third lens 230 has positive refractive power, the fourth lens 240 has negative refractive power, and the fifth lens 250 may have positive refractive power.

Each of the first lens 210 and the third lens 230 may have one surface in a convex or concave shape. For example, the first lens 210 may have a convex object-side surface and a concave image-side surface, and the third lens 230 may have a convex object-side surface and a convex image-side surface.

The imaging lens system 200 may include at least one metalens. For example, in the imaging lens system 200 according to this example embodiment, the second lens 220, the fourth lens 240, and the fifth lens 250 may be metalenses. The object-side surfaces and image-side surfaces of the second lens 220, the fourth lens 240, and the fifth lens 250 that are metalenses may be substantially planar.

Each of the metalenses 220, 240, and 250 may have a unique form. For example, as illustrated in FIGS. 7 to 9, each of the metalenses 220, 240, and 250 may be formed in a quadrangular shape, a rectangular shape, or a circular shape. However, the metalenses 220, 240, and 250 are not limited to the forms illustrated in FIGS. 7 to 9.

The metalenses 220, 240, and 250 may be partitioned into a plurality of regions. For example, each of the metalenses 220, 240, and 250 may include a first region 12 of a blue wavelength, a second region 14 of a green wavelength, a third region 16 of a red wavelength, and a fourth region 18 of a green wavelength. The first region 12 of a blue wavelength, the second region 14 of a green wavelength, the third region 16 of a red wavelength, and the fourth region 18 of a green wavelength may be disposed in a predetermined form. For example, the first region 12 of a blue wavelength, the second region 14 of a green wavelength, the third region 16 of a red wavelength, and the fourth region 18 of a green wavelength may be sequentially formed about the optical axis in the clockwise direction or the counterclockwise direction. In another example, the first region 12 of a blue wavelength may be disposed to be symmetrical to the third region 16 of a red wavelength about the optical axis, and the second region 14 of a green wavelength may be disposed to be symmetrical to the fourth region 18 of a green wavelength about the optical axis.

The imaging lens system 200 may include a filter IF and an imaging plane IP. The filter IF may be disposed between the fifth lens 250 and the imaging plane IP. The imaging plane IP may be formed on an image sensor 900.

The image sensor 900 according to this example embodiment may have features similar to those of the metalenses 220, 240, and 250. For example, as illustrated in FIG. 10, the image sensor 900 may be partitioned into a plurality of regions. In a specific example, the image sensor 900 may include a first region 910 of a blue wavelength, a second region 920 of a green wavelength, a third region 930 of a red wavelength, and a fourth region 940 of a green wavelength. The first region 910 of a blue wavelength, the second region 920 of a green wavelength, the third region 930 of a red wavelength, and the fourth region 940 of a green wavelength may be disposed in a predetermined form. For example, the first region 910 of a blue wavelength, the second region 920 of a green wavelength, the third region 930 of a red wavelength, and the fourth region 940 of a green wavelength may be sequentially formed about the optical axis in the clockwise direction or the counterclockwise direction. In another example, the first region 910 of a blue wavelength may be disposed to be symmetrical to the third region 930 of a red wavelength about the optical axis, and the second region 920 of a green wavelength may be disposed to be symmetrical to the fourth region 940 of a green wavelength about the optical axis.

The first region 910 of a blue wavelength, the second region 920 of a green wavelength, the third region 930 of a red wavelength, and the fourth region 940 of a green wavelength of the image sensor 900 may independently converge light emitted from the first regions 12 to the fourth regions 18 of the metalenses 220, 240, and 250. For example, the first region 910 of the image sensor 900 corresponding to a blue wavelength may image light refracted by the first regions 12 of the metalenses 220, 240, and 250, the second region 920 and the fourth region 940 of the image sensor 900 corresponding to a green wavelength may image light refracted by the second regions 14 and the fourth regions 18 of the metalenses 220, 240, and 250, and the third region 930 of the image sensor 900 corresponding to a red wavelength may image light refracted by the third regions 16 of the metalenses 220, 240, and 250.

The imaging lens system 200 configured as described above may independently converge light of a blue wavelength, a green wavelength, and a red wavelength through at least one of the metalenses 220, 240, and 250 to implement a clear image. In addition, the imaging lens system 200 according to this example embodiment includes the thin metalenses 220, 240, and 250, thereby significantly reducing a size of the imaging lens system 200.

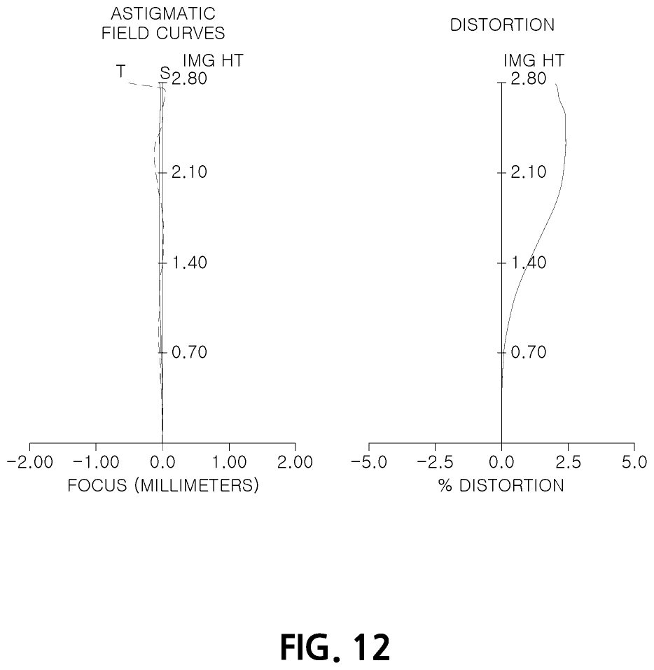

FIGS. 12, 14, and 16 illustrate aberration features of the imaging lens system 200 according to this example embodiment. Tables 7 to 9 show lens features of the imaging lens system 200 according to this example embodiment, and Tables 10 to 12 show phase function values of the imaging lens system 200 according to this example embodiment.

TABLE 7

| Surface | | Radius of | Thickness/ | Refractive | Abbe | Focal |
|---|---|---|---|---|---|---|
| No. | Configuration | Curvature | Distance | Index | Number | Length |
| S1 | First lens | 1.6956 | 0.1604 | 1.5411 | 55.9901 | −11.731 |
| S2 | | 1.2937 | 0.1067 | 1 | 0 | |
| S3 | Second lens | infinity | 0.1492 | 1.4564 | 67.7954 | 1.555 |
| S4 | | infinity | 0.0200 | 1 | 0 | |
| S5 | Third lens | 20.5697 | 0.2100 | 1.5411 | 55.9901 | 7.018 |
| S6 | | −4.6409 | 0.0200 | 1 | 0 | |
| S7 | Fourth lens | infinity | 0.2588 | 1.4564 | 67.7954 | −2.162 |
| S8 | | infinity | 0.3077 | 1 | 0 | |
| S9 | Fifth lens | infinity | 0.2203 | 1.4564 | 67.7954 | 20.784 |
| S10 | | infinity | 0.0501 | 1 | 0 | |
| S11 | Filter | infinity | 0.2100 | 1.5143 | 64.1664 | |
| S12 | | infinity | 2.0869 | 1 | 0 | |
| S13 | Image plane | infinity | 0.0000 | 1 | 0 | |

TABLE 8

| Surface | | Radius of | Thickness/ | Refractive | Abbe | Focal |
|---|---|---|---|---|---|---|
| No. | Configuration | Curvature | Distance | Index | Number | Length |
| S1 | First lens | 1.6956 | 0.1600 | 1.5463 | 55.9901 | −11.626 |
| S2 | | 1.2946 | 0.1060 | 1 | 0 | |
| S3 | Second lens | infinity | 0.1500 | 1.4601 | 67.7954 | 1.559 |
| S4 | | infinity | 0.0200 | 1 | 0 | |
| S5 | Third lens | 20.4385 | 0.2100 | 1.5463 | 55.9901 | 6.930 |
| S6 | | −4.6296 | 0.0200 | 1 | 0 | |
| S7 | Fourth lens | infinity | 0.2610 | 1.4601 | 67.7954 | −2.120 |
| S8 | | infinity | 0.3065 | 1 | 0 | |
| S9 | Fifth lens | infinity | 0.2191 | 1.4601 | 67.7954 | 17.926 |
| S10 | | infinity | 0.0501 | 1 | 0 | |
| S11 | Filter | infinity | 0.2100 | 1.5187 | 64.1664 | |
| S12 | | infinity | 2.0873 | 1 | 0 | |
| S13 | Image plane | infinity | 0.0000 | 1 | 0 | |

TABLE 9

| Surface | | Radius of | Thickness/ | Refractive | Abbe | Focal |
|---|---|---|---|---|---|---|
| No. | Configuration | Curvature | Distance | Index | Number | Length |
| S1 | First lens | 1.6956 | 0.1600 | 1.5563 | 55.9901 | −11.632 |
| S2 | | 1.2942 | 0.1069 | 1 | 0 | |
| S3 | Second lens | infinity | 0.1491 | 1.4667 | 67.7954 | 1.553 |
| S4 | | infinity | 0.0200 | 1 | 0 | |
| S5 | Third lens | 19.7916 | 0.2121 | 1.5563 | 55.9901 | 6.532 |
| S6 | | −4.4337 | 0.0221 | 1 | 0 | |
| S7 | Fourth lens | infinity | 0.2484 | 1.4667 | 67.7954 | −2.129 |
| S8 | | infinity | 0.3171 | 1 | 0 | |
| S9 | Fifth lens | infinity | 0.2171 | 1.4667 | 67.7954 | 20.401 |
| S10 | | infinity | 0.0501 | 1 | 0 | |
| S11 | Filter | infinity | 0.2100 | 1.5267 | 64.1664 | |
| S12 | | infinity | 2.0869 | 1 | 0 | |
| S13 | Image plane | infinity | 0.0000 | 1 | 0 | |

TABLE 10

| Surface | | | | | | | | |
|---|---|---|---|---|---|---|---|---|
| No. | K | 2nd | 4th | 6th | 8th | 10th | 12th | 14th |
| S1 | 0 | 0 | −0.5641 | 0.3281 | −4.4809 | 25.5872 | −68.9453 | 108.2233 |
| S2 | 0 | 0 | −0.6011 | 0.3818 | −9.5525 | 63.6395 | −216.7249 | 431.9019 |
| S3 | −0.6914 | −0.6914 | 0.2153 | 0.0681 | 0.2369 | 0.1534 | 0.0108 | −0.0824 |
| S4 | 0.431 | 0.431 | −0.2999 | −0.1691 | −0.1521 | −0.0774 | 0.0088 | 0.057 |
| S5 | 0 | 0 | −0.1051 | −0.4025 | −2.5125 | 29.5416 | −99.7721 | 183.2575 |
| S6 | 0 | 0 | −0.2161 | 0.3945 | −2.517 | 36.4305 | −178.0909 | 461.6841 |
| S7 | 0.27 | 0.27 | −0.4548 | 0.087 | 0.1934 | −0.0111 | −0.2324 | −0.1501 |
| S8 | −0.0353 | −0.0353 | 0.5284 | 0.1406 | −0.6239 | 0.4743 | 2.008 | 2.1284 |
| S9 | 0.4313 | 0.4313 | −0.2214 | 0.2132 | −0.1374 | −0.0951 | 0.1171 | 0.118 |
| S10 | −0.4028 | −0.4028 | 0.0778 | −0.0341 | 0.0108 | −0.0074 | 0.0046 | 0.0079 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | −101.1052 | 52.0679 | −11.3498 | 0 | 0 | 0 | 0 | 0 |
| S2 | −504.3267 | 319.8267 | −84.8509 | 0 | 0 | 0 | 0 | 0 |
| S3 | −0.0973 | −0.0571 | −0.0357 | 0 | 0 | 0 | 0 | 0 |
| S4 | 0.0685 | 0.0582 | 0.0307 | 0 | 0 | 0 | 0 | 0 |
| S5 | −205.0853 | 131.4258 | −36.3286 | 0 | 0 | 0 | 0 | 0 |
| S6 | −687.7211 | 552.3773 | −183.9733 | 0 | 0 | 0 | 0 | 0 |
| S7 | 0.0762 | 0.2324 | −0.1467 | 0 | 0 | 0 | 0 | 0 |
| S8 | −5.1773 | −9.1021 | 13.7677 | 0 | 0 | 0 | 0 | 0 |
| S9 | −0.1023 | −0.0825 | 0.064 | 0 | 0 | 0 | 0 | 0 |
| S10 | −0.0118 | 0.0055 | −0.0009 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

TABLE 11

| Surface | | | | | | | | |
|---|---|---|---|---|---|---|---|---|
| No. | K | 2nd | 4th | 6th | 8th | 10th | 12th | 14th |
| S1 | 0 | 0 | −0.5641 | 0.3281 | −4.4809 | 25.5872 | −68.9453 | 108.2233 |
| S2 | 0 | 0 | −0.6011 | 0.3818 | −9.5525 | 63.6395 | −216.7249 | 431.9019 |
| S3 | −0.6951 | −0.6951 | 0.2153 | 0.0682 | 0.2375 | 0.1533 | 0.0066 | −0.0903 |
| S4 | 0.4367 | 0.4367 | −0.3024 | −0.1709 | −0.1501 | −0.0747 | 0.0106 | 0.0574 |
| S5 | 0 | 0 | −0.1051 | −0.4025 | −2.5125 | 29.5416 | −99.7721 | 183.2575 |
| S6 | 0 | 0 | −0.2161 | 0.3945 | −2.517 | 36.4305 | −178.0909 | 461.6841 |
| S7 | 0.2639 | 0.2639 | −0.4478 | 0.0898 | 0.1904 | −0.0154 | −0.2361 | −0.1508 |
| S8 | −0.0256 | −0.0256 | 0.5239 | 0.1427 | −0.63 | 0.4647 | 1.9928 | 2.1567 |
| S9 | 0.4316 | 0.4316 | −0.2202 | 0.212 | −0.1373 | −0.0947 | 0.1174 | 0.118 |
| S10 | −0.4068 | −0.4068 | 0.0786 | −0.0345 | 0.0109 | −0.0073 | 0.0046 | 0.0079 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | −101.1052 | 52.0679 | −11.3498 | 0 | 0 | 0 | 0 | 0 |
| S2 | −504.3267 | 319.8267 | −84.8509 | 0 | 0 | 0 | 0 | 0 |
| S3 | −0.1043 | −0.0558 | −0.0158 | 0 | 0 | 0 | 0 | 0 |
| S4 | 0.0676 | 0.0559 | 0.0269 | 0 | 0 | 0 | 0 | 0 |
| S5 | −205.0853 | 131.4258 | −36.3286 | 0 | 0 | 0 | 0 | 0 |
| S6 | −687.7211 | 552.3773 | −183.9733 | 0 | 0 | 0 | 0 | 0 |
| S7 | 0.0825 | 0.2413 | −0.129 | 0 | 0 | 0 | 0 | 0 |
| S8 | −4.9923 | −8.7698 | 12.4733 | 0 | 0 | 0 | 0 | 0 |
| S9 | −0.1025 | −0.083 | 0.0644 | 0 | 0 | 0 | 0 | 0 |
| S10 | −0.0118 | 0.0055 | −0.0009 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

TABLE 12

| Surface | | | | | | | | |
|---|---|---|---|---|---|---|---|---|
| No. | K | 2nd | 4th | 6th | 8th | 10th | 12th | 14th |
| S1 | 0 | 0 | −0.5641 | 0.3281 | −4.4809 | 25.5872 | −68.9453 | 108.2233 |
| S2 | 0 | 0 | −0.6011 | 0.3818 | −9.5525 | 63.6395 | −216.7249 | 431.9019 |
| S3 | −0.7117 | −0.7117 | 0.2236 | 0.0708 | 0.2397 | 0.1435 | 0.0069 | −0.0699 |
| S4 | 0.4556 | 0.4556 | −0.3077 | −0.1811 | −0.1555 | −0.0727 | 0.0172 | 0.061 |
| S5 | 0 | 0 | −0.1051 | −0.4025 | −2.5125 | 29.5416 | −99.7721 | 183.2575 |
| S6 | 0 | 0 | −0.2161 | 0.3945 | −2.517 | 36.4305 | −178.0909 | 461.6841 |
| S7 | 0.2985 | 0.2985 | −0.5105 | 0.1388 | 0.2099 | −0.0619 | −0.3033 | −0.1536 |
| S8 | −0.0578 | −0.0578 | 0.5458 | 0.1651 | −0.7146 | 0.4545 | 2.2287 | 2.4722 |
| S9 | 0.4258 | 0.4258 | −0.2044 | 0.2059 | −0.1373 | −0.0956 | 0.1158 | 0.1176 |
| S10 | −0.3999 | −0.3999 | 0.0728 | −0.033 | 0.011 | −0.0074 | 0.0046 | 0.0079 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | −101.1052 | 52.0679 | −11.3498 | 0 | 0 | 0 | 0 | 0 |
| S2 | −504.3267 | 319.8267 | −84.8509 | 0 | 0 | 0 | 0 | 0 |
| S3 | −0.0752 | −0.0493 | −0.0795 | 0 | 0 | 0 | 0 | 0 |
| S4 | 0.0644 | 0.0499 | 0.0339 | 0 | 0 | 0 | 0 | 0 |
| S5 | −205.0853 | 131.4258 | −36.3286 | 0 | 0 | 0 | 0 | 0 |
| S6 | −687.7211 | 552.3773 | −183.9733 | 0 | 0 | 0 | 0 | 0 |
| S7 | 0.1849 | 0.4479 | −0.4294 | 0 | 0 | 0 | 0 | 0 |
| S8 | −5.7445 | −9.8319 | 14.8318 | 0 | 0 | 0 | 0 | 0 |
| S9 | −0.0996 | −0.0788 | 0.0601 | 0 | 0 | 0 | 0 | 0 |
| S10 | −0.0119 | 0.0054 | −0.0009 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

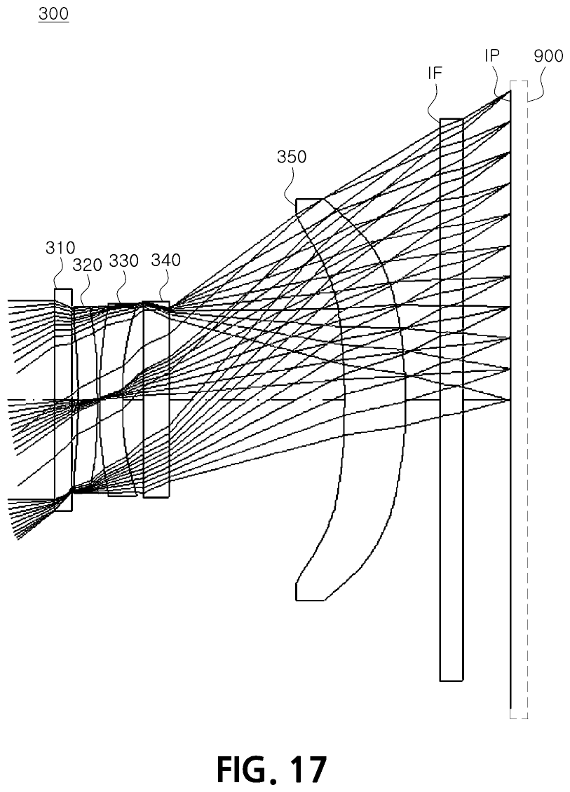

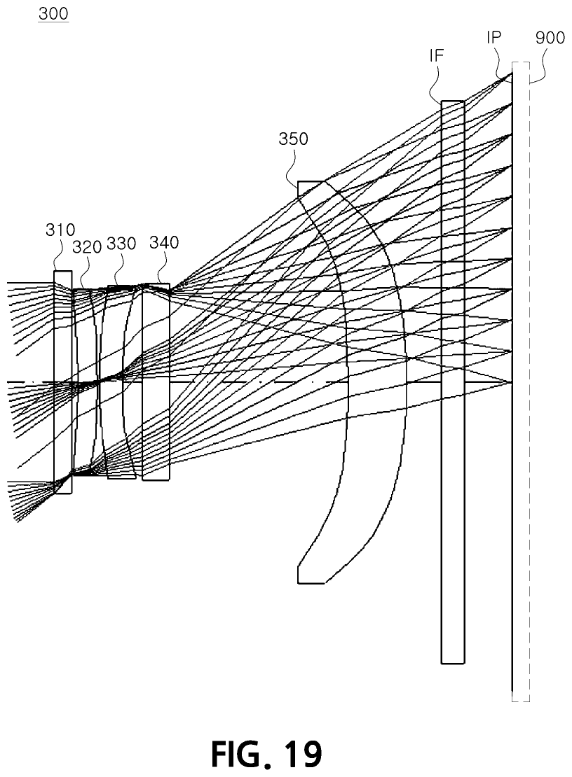

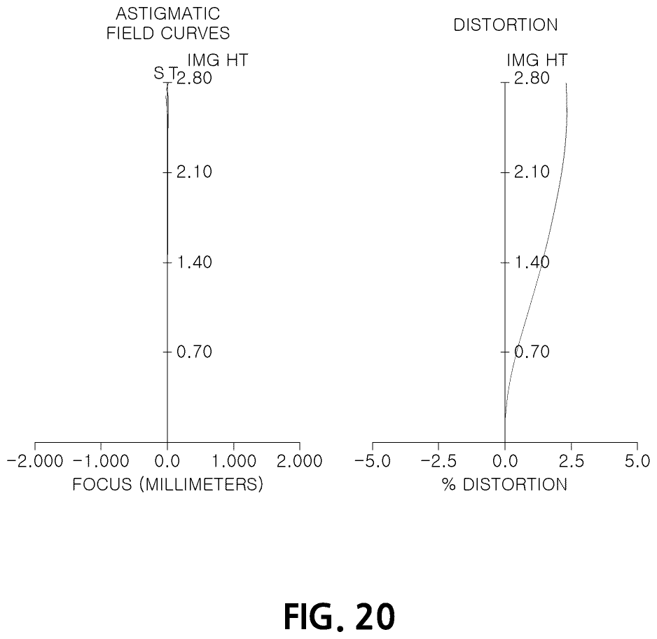

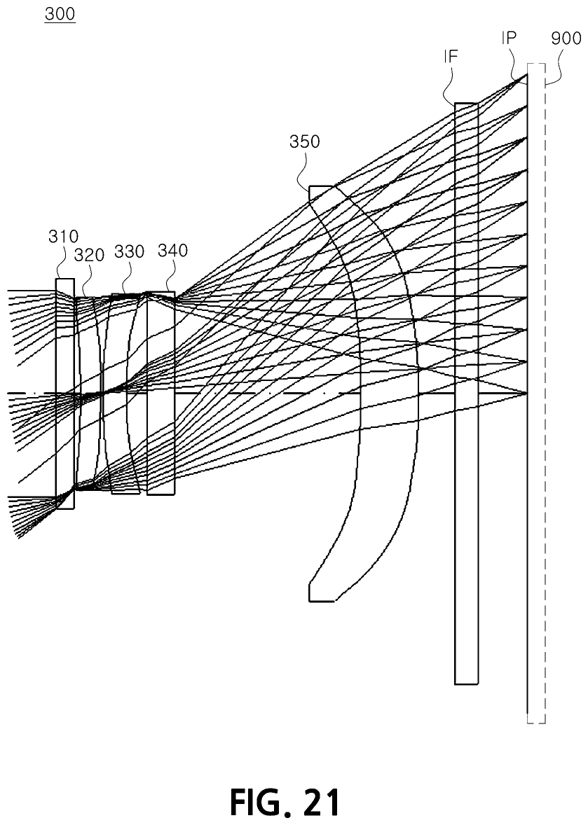

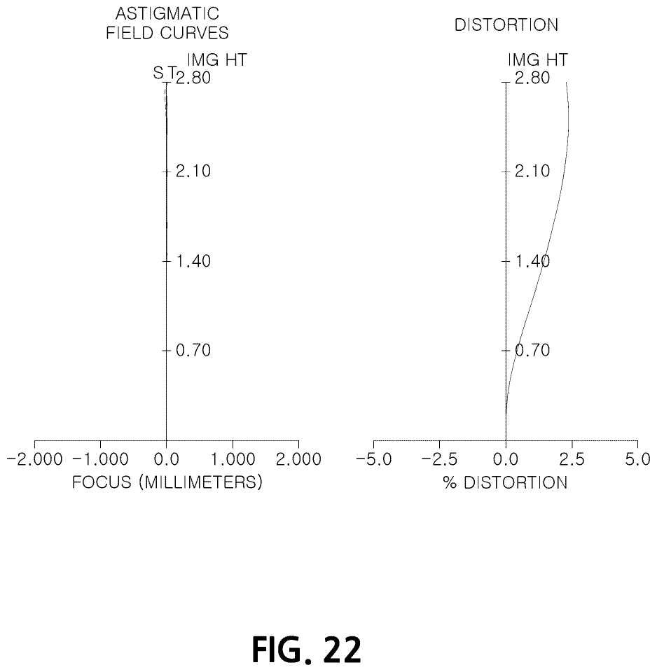

Hereinafter, an imaging lens system according to a third example embodiment is described with reference to FIGS. 17 to 22.

An imaging lens system 300 may include a lens group. For example, the imaging lens system 300 may include one lens group disposed between an object and an image plane IP. The lens group may include at least one lens. For example, the lens group of the imaging lens system 300 may include a first lens 310, a second lens 320, a third lens 330, a fourth lens 340, and a fifth lens 350.

Each of the first lens 310 to the fifth lens 350 may have predetermined refractive power. For example, the first lens 310 may have positive refractive power, the second lens 320 may have negative refractive power, the third lens 330 may have positive refractive power, the fourth lens 340 may have positive refractive power, and the fifth lens 350 may have positive refractive power.

Each of the second lens 320, the third lens 330, and the fifth lens 350 may have one surface in a convex or concave shape. For example, the second lens 320 may have a concave object-side surface and a convex image-side surface, the third lens 330 may have a convex object-side surface and a concave image-side surface, and the fifth lens 350 may have a concave object-side surface and a convex image-side surface.

The imaging lens system 300 may include at least one metalens. For example, in the imaging lens system 300 according to this example embodiment, the first lens 310 and the fourth lens 340 may be metalenses. The object-side surfaces and image-side surfaces of the first lens 310 and the fourth lens 340 that are metalenses may be substantially planar.

Each of the metalenses 310 and 340 may have a unique form. For example, as illustrated in FIGS. 7 to 9, each of the metalenses 310 and 340 may be formed in a quadrangular shape, a rectangular shape, or a circular shape. However, the metalenses 310 and 340 are not limited to the forms illustrated in FIGS. 7 to 9.

Each of the metalenses 310 and 340 may be partitioned into a plurality of regions. For example, each of the metalenses 310 and 340 may include a first region 12 of a blue wavelength, a second region 14 of a green wavelength, a third region 16 of a red wavelength, and a fourth region 18 of a green wavelength. The first region 12 of a blue wavelength, the second region 14 of a green wavelength, the third region 16 of a red wavelength, and the fourth region 18 of a green wavelength may be disposed in a predetermined form. For example, the first region 12 of a blue wavelength, the second region 14 of a green wavelength, the third region 16 of a red wavelength, and the fourth region 18 of a green wavelength may be sequentially formed about the optical axis in the clockwise direction or the counterclockwise direction. In another example, the first region 12 of a blue wavelength may be disposed to be symmetrical to the third region 16 of a red wavelength about the optical axis, and the second region 14 of a green wavelength may be disposed to be symmetrical to the fourth region 18 of a green wavelength about the optical axis.

The imaging lens system 300 may include a filter IF and an image plane IP. The filter IF may be disposed between the fifth lens 350 and the image plane IP. The image plane IP may be formed on an image sensor 900.

The image sensor 900 according to this example embodiment may have features similar to those of the metalenses 310 and 340. For example, as illustrated in FIG. 10, the image sensor 900 may be partitioned into a plurality of regions. In a specific example, the image sensor 900 may include a first region 910 of a blue wavelength, a second region 920 of a green wavelength, a third region 930 of a red wavelength, and a fourth region 940 of a green wavelength. The first region 910 of a blue wavelength, the second region 920 of a green wavelength, the third region 930 of a red wavelength, and the fourth region 940 of a green wavelength may be disposed in a predetermined form. For example, the first region 910 of a blue wavelength, the second region 920 of a green wavelength, the third region 930 of a red wavelength, and the fourth region 940 of a green wavelength may be sequentially formed about the optical axis along the clockwise direction or the counterclockwise direction. In another example, the first region 910 of a blue wavelength may be disposed to be symmetrical to the third region 930 of a red wavelength about the optical axis, and the second region 920 of a green wavelength may be disposed to be symmetrical to the fourth region 940 of a green wavelength about the optical axis.

The first region 910 of a blue wavelength, the second region 920 of a green wavelength, the third region 930 of a red wavelength, and the fourth region 940 of a green wavelength of the image sensor 900 may independently converge light emitted from the first region 12 to the fourth region 18 of the metalenses 320, 240, and 250. For example, the first region 910 of the image sensor 900 corresponding to a blue wavelength may image light refracted by the first regions 12 of the metalenses 310 and 340, the second region 920 and the fourth region 940 of the image sensor 900 corresponding to a green wavelength may image light refracted by the second regions 14 and the fourth regions 18 of the metalenses 310 and 340, and the third region 930 of the image sensor 900 corresponding to a red wavelength may image light refracted by the third regions 16 of the metalenses 310 and 340.

The imaging lens system 300 configured as described above may independently converge light of a blue wavelength, a green wavelength, and a red wavelength through at least one of the metalenses 310 and 340 to implement a clear image. In addition, the imaging lens system 300 according to this example embodiment includes the thin metalenses 310 and 340, thereby significantly reducing a size of the imaging lens system 300.

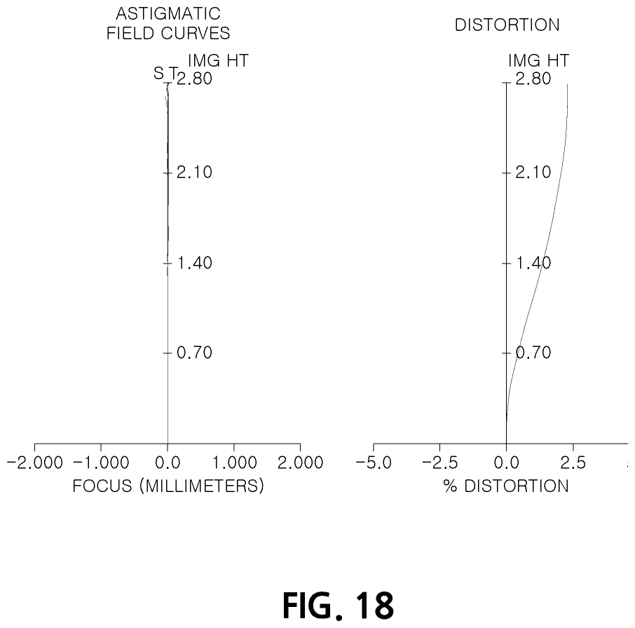

FIGS. 18, 20, and 22 illustrate aberration features of the imaging lens system 300 according to this example embodiment. Tables 13 to 15 show lens features of the imaging lens system 300 according to this example embodiment, and Tables 16 to 18 show phase function values of the imaging lens system 300 according to this example embodiment.

TABLE 13

| Surface | | Radius of | Thickness/ | Refractive | Abbe | Focal |
|---|---|---|---|---|---|---|
| No. | Configuration | Curvature | Distance | Index | Number | Length |
| S1 | First lens | infinity | 0.1660 | 1.4564 | 67.7954 | 6.353 |
| S2 | | infinity | 0.0538 | 1 | 0 | |
| S3 | Second lens | −5.3621 | 0.1800 | 1.6077 | 25.9363 | −19.149 |
| S4 | | −10.0706 | 0.0200 | 1 | 0 | |
| S5 | Third lens | 7.3951 | 0.2130 | 1.5416 | 55.9193 | 144.871 |
| S6 | | 8.0820 | 0.1879 | 1 | 0 | |
| S7 | Fourth lens | infinity | 0.2387 | 1.4564 | 67.7954 | 5.066 |
| S8 | | infinity | 1.6166 | 1 | 0 | |
| S9 | Fifth lens | −9.1758 | 0.5605 | 1.5416 | 55.9193 | 20.904 |
| S10 | | −5.1770 | 0.3210 | 1 | 0 | |
| S11 | Filter | infinity | 0.2100 | 1.5143 | 64.1664 | |
| S12 | | infinity | 0.4324 | 1 | 0 | |
| S13 | Image plane | infinity | 0.0000 | 1 | 0 | |

TABLE 14

| Surface | | Radius of | Thickness/ | Refractive | Abbe | Focal |
|---|---|---|---|---|---|---|
| No. | Configuration | Curvature | Distance | Index | Number | Length |
| S1 | First lens | infinity | 0.1664 | 1.4601 | 67.7954 | 6.400 |
| S2 | | infinity | 0.0536 | 1 | 0 | |
| S3 | Second lens | −5.3863 | 0.1800 | 1.62 | 25.9363 | −19.132 |
| S4 | | −9.9926 | 0.0200 | 1 | 0 | |
| S5 | Third lens | 7.4941 | 0.2100 | 1.5468 | 55.9193 | 161.291 |
| S6 | | 8.1089 | 0.1855 | 1 | 0 | |
| S7 | Fourth lens | infinity | 0.2454 | 1.4601 | 67.7954 | 5.027 |
| S8 | | infinity | 1.6364 | 1 | 0 | |
| S9 | Fifth lens | −9.1614 | 0.5398 | 1.5468 | 55.9193 | 20.705 |
| S10 | | −5.1692 | 0.3210 | 1 | 0 | |
| S11 | Filter | infinity | 0.2100 | 1.5187 | 64.1664 | |
| S12 | | infinity | 0.4320 | 1 | 0 | |
| S13 | Image plane | infinity | 0.0000 | 1 | 0 | |

TABLE 15

| Surface | | Radius of | Thickness/ | Refractive | Abbe | Focal |
|---|---|---|---|---|---|---|
| No. | Configuration | Curvature | Distance | Index | Number | Length |
| S1 | First lens | infinity | 0.1673 | 1.4667 | 67.7954 | 6.354 |
| S2 | | infinity | 0.0531 | 1 | 0 | |
| S3 | Second lens | −5.4338 | 0.1800 | 1.6461 | 25.9363 | −18.399 |
| S4 | | −10.1390 | 0.0200 | 1 | 0 | |
| S5 | Third lens | 7.5061 | 0.2100 | 1.5568 | 55.9193 | 152.535 |
| S6 | | 8.1514 | 0.1839 | 1 | 0 | |
| S7 | Fourth lens | infinity | 0.2498 | 1.4667 | 67.7954 | 5.023 |
| S8 | | infinity | 1.6556 | 1 | 0 | |
| S9 | Fifth lens | −9.2557 | 0.5173 | 1.5568 | 55.9193 | 20.357 |
| S10 | | −5.1970 | 0.3210 | 1 | 0 | |
| S11 | Filter | infinity | 0.2100 | 1.5267 | 64.1664 | |
| S12 | | infinity | 0.4320 | 1 | 0 | |
| S13 | Image plane | infinity | 0.0000 | 1 | 0 | |

TABLE 16

| Surface | | | | | | | | |
|---|---|---|---|---|---|---|---|---|
| No. | K | 2nd | 4th | 6th | 8th | 10th | 12th | 14th |
| S1 | −0.453 | −0.453 | 0.1718 | −0.1076 | 0.1183 | −0.1611 | 0.0899 | 0.0542 |
| S2 | 0.4174 | 0.4174 | −0.1185 | 0.2153 | −1.1703 | 1.9864 | 4.9138 | −16.0808 |
| S3 | 9.7159 | 9.7159 | 0.2655 | −0.5597 | −3.4914 | 25.0949 | −76.4289 | 150.6597 |
| S4 | 95 | 95 | 0.2566 | −3.6373 | 16.7154 | −44.065 | 72.0558 | −72.0981 |
| S5 | 10.1486 | 10.1486 | 0.4203 | −3.4716 | 18.3225 | −56.8629 | 108.0064 | −126.1948 |
| S6 | 74.4885 | 74.4885 | 0.2955 | −0.1228 | −0.4727 | 2.1787 | −10.1001 | 26.518 |
| S7 | −0.0485 | −0.0485 | −0.1979 | −0.0154 | −0.0395 | −0.0047 | 0.0559 | 0.029 |
| S8 | −0.051 | −0.051 | 0.1497 | 0.0508 | 0.0399 | 0.0192 | 0.0205 | 0.0062 |
| S9 | −61.324 | −61.324 | −0.0485 | −0.0084 | 0.027 | −0.0503 | 0.0502 | −0.0291 |
| S10 | −28.4609 | −28.4609 | −0.0518 | 0.0185 | −0.0288 | 0.0291 | −0.0203 | 0.0091 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | −0.0351 | −0.0518 | 0.0331 | 0 | 0 | 0 | 0 | 0 |
| S2 | 3.9339 | 22.6852 | −17.5137 | 0 | 0 | 0 | 0 | 0 |
| S3 | −208.8479 | 181.7386 | −70.6699 | 0 | 0 | 0 | 0 | 0 |
| S4 | 39.5528 | −6.2543 | −2.9462 | 0 | 0 | 0 | 0 | 0 |
| S5 | 85.5942 | −28.0022 | 1.8444 | 0 | 0 | 0 | 0 | 0 |
| S6 | −37.4795 | 27.5536 | −8.5353 | 0 | 0 | 0 | 0 | 0 |
| S7 | −0.1144 | −0.1866 | 0.2715 | 0 | 0 | 0 | 0 | 0 |
| S8 | 0.0042 | 0.069 | 0.0147 | 0 | 0 | 0 | 0 | 0 |
| S9 | 0.0098 | −0.0017 | 0.0001 | 0 | 0 | 0 | 0 | 0 |
| S10 | −0.0025 | 0.0004 | 0 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

TABLE 17

| Surface | | | | | | | | |
|---|---|---|---|---|---|---|---|---|
| No. | K | 2nd | 4th | 6th | 8th | 10th | 12th | 14th |
| S1 | −0.4537 | −0.4537 | 0.1716 | −0.1078 | 0.1192 | −0.1612 | 0.089 | 0.0539 |
| S2 | 0.4189 | 0.4189 | −0.1164 | 0.2164 | −1.1696 | 1.9863 | 4.9121 | −16.0844 |
| S3 | 10.0294 | 10.0294 | 0.2617 | −0.546 | −3.4434 | 24.808 | −75.8389 | 149.5392 |
| S4 | 95 | 95 | 0.2428 | −3.4974 | 16.131 | −42.5922 | 69.1236 | −67.1342 |
| S5 | 6.5773 | 6.5773 | 0.4111 | −3.3867 | 18.1003 | −57.1468 | 110.7106 | −132.6793 |
| S6 | 73.9455 | 73.9455 | 0.297 | −0.1362 | −0.3407 | 1.4229 | −7.7243 | 21.9974 |
| S7 | −0.0489 | −0.0489 | −0.1981 | −0.0141 | −0.0393 | −0.0046 | 0.0562 | 0.0293 |
| S8 | −0.0514 | −0.0514 | 0.1486 | 0.0494 | 0.0401 | 0.0188 | 0.0188 | 0.0051 |
| S9 | −61.1288 | −61.1288 | −0.0486 | −0.0072 | 0.0231 | −0.0437 | 0.0436 | −0.0252 |
| S10 | −28.3066 | −28.3066 | −0.0519 | 0.0186 | −0.029 | 0.029 | −0.0201 | 0.009 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | −0.0344 | −0.0508 | 0.0323 | 0 | 0 | 0 | 0 | 0 |
| S2 | 3.93 | 22.6859 | −17.4982 | 0 | 0 | 0 | 0 | 0 |
| S3 | −206.5423 | 178.8542 | −69.2537 | 0 | 0 | 0 | 0 | 0 |
| S4 | 33.4127 | −1.824 | −4.2743 | 0 | 0 | 0 | 0 | 0 |
| S5 | 93.6877 | −33.4415 | 3.4286 | 0 | 0 | 0 | 0 | 0 |
| S6 | −32.1549 | 23.9574 | −7.4593 | 0 | 0 | 0 | 0 | 0 |
| S7 | −0.1145 | −0.1873 | 0.2707 | 0 | 0 | 0 | 0 | 0 |
| S8 | 0.0059 | 0.0717 | 0.008 | 0 | 0 | 0 | 0 | 0 |
| S9 | 0.0084 | −0.0015 | 0.0001 | 0 | 0 | 0 | 0 | 0 |
| S10 | −0.0024 | 0.0004 | 0 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

TABLE 18

| Surface | | | | | | | | |
|---|---|---|---|---|---|---|---|---|
| No. | K | 2nd | 4th | 6th | 8th | 10th | 12th | 14th |
| S1 | −0.455 | −0.455 | 0.1719 | −0.1082 | 0.1201 | −0.1611 | 0.0883 | 0.0535 |
| S2 | 0.4199 | 0.4199 | −0.1148 | 0.2164 | −1.1694 | 1.9866 | 4.9118 | −16.086 |
| S3 | 10.3347 | 10.3347 | 0.2561 | −0.5416 | −3.2808 | 23.9506 | −73.4936 | 144.9192 |
| S4 | 94.8736 | 94.8736 | 0.232 | −3.3806 | 15.648 | −41.4858 | 67.5928 | −65.8723 |
| S5 | 4.2058 | 4.2058 | 0.4056 | −3.3501 | 18.0411 | −57.4864 | 112.6395 | −137.1218 |
| S6 | 73.7887 | 73.7887 | 0.2961 | −0.1473 | −0.244 | 0.9156 | −6.0185 | 18.3931 |
| S7 | −0.0489 | −0.0489 | −0.1984 | −0.0131 | −0.0394 | −0.0048 | 0.0563 | 0.0295 |
| S8 | −0.0515 | −0.0515 | 0.1483 | 0.0489 | 0.0404 | 0.0188 | 0.0179 | 0.0047 |
| S9 | −65.4451 | −65.4451 | −0.0485 | −0.0071 | 0.0227 | −0.0424 | 0.0419 | −0.024 |
| S10 | −28.921 | −28.921 | −0.0522 | 0.0192 | −0.0303 | 0.0305 | −0.0211 | 0.0094 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

| Surface | | | | | | | | |
|---|---|---|---|---|---|---|---|---|
| No. | 16th | 18th | 20th | 22nd | 24th | 26th | 28th | 30th |
| S1 | −0.0339 | −0.0501 | 0.0318 | 0 | 0 | 0 | 0 | 0 |
| S2 | 3.9276 | 22.685 | −17.4906 | 0 | 0 | 0 | 0 | 0 |
| S3 | −199.6554 | 172.3659 | −66.5829 | 0 | 0 | 0 | 0 | 0 |
| S4 | 32.8436 | −1.7639 | −4.2139 | 0 | 0 | 0 | 0 | 0 |
| S5 | 99.2453 | −37.1593 | 4.4818 | 0 | 0 | 0 | 0 | 0 |
| S6 | −27.5192 | 20.6424 | −6.4441 | 0 | 0 | 0 | 0 | 0 |
| S7 | −0.1142 | −0.1871 | 0.2708 | 0 | 0 | 0 | 0 | 0 |
| S8 | 0.0077 | 0.0743 | 0.0024 | 0 | 0 | 0 | 0 | 0 |
| S9 | 0.0079 | −0.0014 | 0.0001 | 0 | 0 | 0 | 0 | 0 |
| S10 | −0.0025 | 0.0004 | 0 | 0 | 0 | 0 | 0 | 0 |
| S11 | 0 | 0 | 0 | 0 | 0 | 0 | 0 | 0 |
| S12 | 0 | 0 | 0 | 0 | 0 | 0 | 0 | 0 |
| S13 | 0 | 0 | 0 | 0 | 0 | 0 | 0 | 0 |

Table 19 shows feature values of the imaging lens system according to first to third example embodiments.

TABLE 19

| | First Example Embodiment | | | Second Example Embodiment | | |
|---|---|---|---|---|---|---|
| | Red | Green | Blue | Red | Green | Blue |
| Remarks | wavelength | wavelength | wavelength | wavelength | wavelength | wavelength |
| TTL | 3.700 | 3.700 | 3.700 | 3.800 | 3.800 | 3.800 |
| BFL | 1.680 | 1.680 | 1.680 | 2.347 | 2.347 | 2.347 |
| f | 3.500 | 3.500 | 3.500 | 3.500 | 3.500 | 3.500 |
| F number | 1.880 | 1.880 | 1.880 | 2.060 | 2.060 | 2.060 |
| ImgHT | 2.800 | 2.800 | 2.800 | 2.800 | 2.800 | 2.800 |
| f12 | 2.349 | 2.349 | 2.349 | 3.771 | 3.771 | 3.771 |
| f34 | 2.163 | 2.163 | 2.163 | 4.176 | 4.176 | 4.176 |

| | Third Example Embodiment | | |
|---|---|---|---|
| | Red | Green | Blue |
| Remarks | wavelength | wavelength | wavelength |
| TTL | 4.200 | 4.200 | 4.200 |
| BFL | 0.963 | 0.963 | 0.963 |
| f | 3.500 | 3.500 | 3.500 |
| F number | 1.950 | 1.950 | 1.950 |
| ImgHT | 2.800 | 2.800 | 2.800 |
| f12 | 16.430 | 16.430 | 16.430 |
| f34 | 2.784 | 2.784 | 2.784 |

Table 20 shows values of conditional expressions of the imaging lens system according to first to third example embodiments.

TABLE 20

| | First Example Embodiment | | | Second Example Embodiment | | |
|---|---|---|---|---|---|---|
| Conditional | Red | Green | Blue | Red | Green | Blue |
| expression | wavelength | wavelength | wavelength | wavelength | wavelength | wavelength |
| f1/f | 9.436 | 5.475 | 11.033 | −3.352 | −3.322 | −3.323 |
| f2/f | 0.795 | 0.906 | 0.772 | 0.444 | 0.445 | 0.444 |
| f3/f | −2.758 | −4.486 | −2.605 | 2.005 | 1.980 | 1.866 |
| f4/f | 0.520 | 0.409 | 0.480 | −0.618 | −0.606 | −0.608 |
| f5/f | −0.568 | −0.436 | −0.523 | 5.938 | 5.122 | 5.829 |
| TTL/f | 1.057 | 1.057 | 1.057 | 1.086 | 1.086 | 1.086 |
| f1/f2 | 11.865 | 6.043 | 14.293 | −7.542 | −7.459 | −7.492 |
| f2/f3 | −0.288 | −0.202 | −0.296 | 0.222 | 0.225 | 0.238 |
| BFL/f | 0.517 | 0.524 | 0.518 | 0.821 | 0.821 | 0.823 |
| TTL/2Y | 0.661 | 0.661 | 0.661 | 0.679 | 0.679 | 0.679 |
| fM/f | 9.436 | 5.475 | 11.033 | 0.444 | 0.445 | 0.444 |
| fMg/f | 9.436 | 5.475 | 11.033 | 0.444 | 0.445 | 0.444 |
| MS1 | −0.112 | −0.124 | −0.119 | −0.691 | −0.695 | −0.712 |
| MS2 | 0.100 | 0.101 | 0.110 | 0.431 | 0.437 | 0.456 |
| \|f12/f2\| | 0.844 | 0.741 | 0.869 | 2.424 | 2.419 | 2.428 |
| f34/f | 0.618 | 0.618 | 0.618 | 1.193 | 1.193 | 1.193 |

| | Third Example Embodiment | | |
|---|---|---|---|
| Conditional | Red | Green | Blue |
| expression | wavelength | wavelength | wavelength |
| f1/f | 1.815 | 1.829 | 1.816 |
| f2/f | −5.471 | −5.466 | −5.257 |
| f3/f | 41.392 | 46.083 | 43.581 |
| f4/f | 1.448 | 1.436 | 1.435 |
| f5/f | 5.973 | 5.916 | 5.816 |
| TTL/f | 1.200 | 1.200 | 1.200 |
| f1/f2 | −0.332 | −0.335 | −0.345 |
| f2/f3 | −0.132 | −0.119 | −0.121 |
| BFL/f | 0.897 | 0.897 | 0.896 |
| TTL/2Y | 0.750 | 0.750 | 0.750 |
| fM/f | 1.815 | 1.829 | 1.816 |
| fMg/f | 1.815 | 1.829 | 1.816 |
| MS1 | −0.453 | −0.454 | −0.455 |
| MS2 | 0.417 | 0.419 | 0.420 |
| \|f12/f2\| | 0.858 | 0.859 | 0.893 |
| f34/f | 0.795 | 0.795 | 0.795 |

As set forth above, the present disclosure may provide the imaging lens system capable of the miniaturization and thinning of a camera module.

In addition, the present disclosure may provide the imaging lens system capable of correcting the aberration of a camera module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens, a second lens, a third lens, a fourth lens, and a fifth lens sequentially disposed from an object side,
wherein at least one of the first lens to the fifth lens is a metalens.

2. The imaging lens system according to claim 1, wherein the metalens has positive refractive power.

3. The imaging lens system according to claim 1, wherein the first lens or the second lens is the metalens.

4. The imaging lens system according to claim 1, wherein the fourth lens is the metalens.

5. The imaging lens system according to claim 1, wherein at least one of the first lens to the fifth lens has negative refractive power.

6. The imaging lens system according to claim 1, wherein one pair of adjacent lenses among the first lens to the fifth lens each have positive refractive power.

7. The imaging lens system according to claim 1, wherein one of the second lens to the fourth lens has negative refractive power.

8. The imaging lens system according to claim 1, wherein the metalens includes a first region corresponding to a blue wavelength, a second region corresponding to a green wavelength, a third region corresponding to a red wavelength, and a fourth region corresponding to a green wavelength.

9. The imaging lens system according to claim 8, wherein the first region and the second region are respectively symmetrical to the third region and the fourth region about an optical axis.

10. An imaging lens system comprising:
a lens group disposed between an object and an image plane,
wherein the lens group includes at least one metalens.

11. The imaging lens system according to claim 10, wherein the metalens has positive refractive power.

12. The imaging lens system according to claim 10, wherein the lens group includes a lens having negative refractive power.

13. The imaging lens system according to claim 10, wherein the metalens includes a first region corresponding to a blue wavelength, a second region corresponding to a green wavelength, a third region corresponding to a red wavelength, and a fourth region corresponding to a green wavelength.

14. The imaging lens system according to claim 10, wherein the following conditional expression is satisfied:
$$0. 60 < TTL / 2 Y < 0.80 ,$$
where TTL is a distance from an object-side surface of a foremost lens disposed foremost in the lens group to the image plane and 2Y is a diagonal length of the image plane.

15. The imaging lens system according to claim 10, wherein the following conditional expression is satisfied:
$$0. 4 < BFL / f < 1. ,$$
where BFL is a distance from an image-side surface of a rearmost lens disposed rearmost in the lens group to the image plane and f is a focal length of the imaging lens system.
